(19) United States
(12) Patent Application Publication
(10) Pub. No.: US 2010/0333204 A1
(43) Pub. Date: Dec. 30, 2010

(54) SYSTEM AND METHOD FOR VIRUS RESISTANT IMAGE TRANSFER

(75) Inventor: Assaf Shpits, Moshav Bazra (IL)

Correspondence Address: SUGHRUE MION, PLLC, 2100 PENNSYLVANIA AVENUE, N.W., SUITE 800, WASHINGTON, DC, 20037, US

(73) Assignee: WALLTRIX CORP.

(21) Appl. No.: 12/509,944

(22) Filed: Jul. 27, 2009

Related U.S. Application Data
(63) Continuation-in-part of application No. 12/505,125, filed on Jul. 17, 2009.
Application No. 12/505,125 is a continuation-in-part of application No. 12/492,757, filed on Jun. 26, 2009, now abandoned.

(51) Int. Cl. G06F 21/00; G06F 3/048

(52) U.S. Cl. 726/24; 715/838; 726/28

(57) ABSTRACT

A system and method for virus resistant image transfer, comprising a computer capable of accessing electronic sources of information, a connection to a local network, and a connection to the Internet, which enable virus resistant image transfer, by a user opening a computer connection, the user selecting data, the user generating an Internet optimized thumbnail image associated with the selected data, the user converting the selected data to an Internet optimized format, the user creating an Internet optimized pair of the selected data and the thumbnail image, the user compressing all Internet optimized pairs, the user connecting to a server, and the server authenticating the user.

### REFERENCE TO RELATED APPLICATIONS

This application is a continuation-in-part of application Ser. No. 12/505,125, filed on Jul. 17, 2009, entitled, “System and Method for Creating and Manipulating Thumbnail Walls”, which is a continuation-in-part of application Ser. No. 12/492,757, filed on Jun. 26, 2009. The entire disclosures of these prior applications are considered part of the disclosure of this application and are hereby incorporated by reference in their entirety.

This application is also related to the application of Assaf Shpits, filed concurrently herewith, entitled “System and Method for Measuring User Interest in an Advertisement Generated as Part of a Thumbnail Wall”. The entire disclosure of this related application is considered part of the disclosure of this application and is hereby incorporated by reference in its entirety.

### BACKGROUND OF EXEMPLARY EMBODIMENTS OF THE INVENTION

### FIELD OF THE INVENTION

The present invention relates generally to the field of thumbnail walls. Nowadays users of electronic platforms can browse by calling up multiple thumbnail images displayed graphically on a screen. This kind of display allows a user to grasp quickly pictures that might be of interest, and then to access such pictures or associated audio by pressing on the thumbnail image of the picture or otherwise indicating a selection. It is further possible to have a moving display of the thumbnail images, in the form of a moving wall, which may be manipulated by angle or by zoom-in or zoom-out. The wall of thumbnail images may be presented through the Internet, or from a private stored area. The present invention describes a system and method for enhancing the creation and manipulation of an electronic thumbnail wall. The present invention describes a system and method for electronically transferring images that are resistant to electronic viruses.

The embodiments described herein are illustrative and non-limiting. Definitions are provided solely to assist one of ordinary skills in the art to better understand these illustrative, non-limiting embodiments. As such, these definitions should not be used to limit the scope of the claims more narrowly that the plain and ordinary meaning of the terms recited in the claims. With that caveat, the following definitions are used:

“Automated wall” is an Internet wall that was created automatically by an information system after the user entered his or her preferred search criteria. If the user modifies the automated wall, then the wall becomes a “personalized wall”.

“Computer” means any

computer,
combination of computers, or
other equipment providing a display similar in kind to that of a computer screen, including, but without limitation, wireless and fixed-line telephones, and any manner of portable or mobile consumer electronic device with a display screen.

“Data source” is a source of data, and specifically, the Internet, or a local computer or other local storage facility, or a remote computer or other remote storage facility, or any combination of the foregoing.

“Enclosed wall”. In a wall within a wall, the wall that is itself one thumbnail of a larger wall is the “enclosed wall”. The larger wall is the “enclosing wall”.

“Enclosing wall”. In a wall within a wall, the wall that includes many thumbnails, at least one thumbnail of which is itself a wall, is the “enclosing wall”. The thumbnail that is a wall is the “enclosed wall”.

“General display”. In various alternative embodiments, multiple users access one displaying device, in which each user may operate one or more of the various embodiments described in this specification. Where multiple users access one displaying device, the displaying device is a “general display”, in contrast to a personal device which is dedicated to each user. Where there is only one user of a displaying device, in one exemplary embodiment the displaying device is not a general display, but rather the personal display of that user. However, the user has the option to transfer the display from the displaying device to a different device (such as, but not limited to, something like an iPhone™ or an Apple iPod™), in which case the displaying device operates as general display in contrast to the user's personal display.

“Improve a previously created personalized wall” includes any action performed by the user of a personalized wall to make the personalized wall more useful or easier to access. Such actions could include, but are not limited to, adding or deleting or changing material associated with an existing thumbnail, adding a new thumbnail, adding or deleting or modifying information associated with a newly added thumbnail, modifying a thumbnail, and adding or deleting or changing material associated with a thumbnail that is modified by the user or by deleting a thumbnail.

“Internet optimized format” is a format of any electronic file that has been minimized to smallest possible size that still allows exact duplication of the image after electronic transfer.

“Internet wall”, or “Internet thumbnail wall”, is a wall of electronic thumbnail images presented on a computer display screen.

“Meshup” is the Internet wall that results from a usage flow. The term includes usage flows that may be considered, according to various technical criteria, “meshups” or “mashups”. The Internet wall may include information from the usage flow in any kind of Web feed format, such as, but only by way of example and not by way of limitation, RSS, RDF, and XML feed formats. Information from the usage flow of a meshup may be data model oblivious or data model driven, and the disparate Web data may be joined by brute force.

“Modifying a data search” means to employ one or more techniques to an automated wall to convert the automated wall into a personalized wall. “Modifying a data search” may also include, but is not required to include, one or more of the techniques employed in “refining a data search”. The term “modifying a data search” is related to, but not the same as, “refining a data search”.

“Pair” is a matching set of thumbnail image, and associated data or content represented by that thumbnail image. When the user clicks or otherwise selects the thumbnail image, he or she receives images of the associated data or content. “Paired content” is data or content associated with a selected thumbnail. “Paired thumbnail” is a thumbnail associated with selected data or content. Further, if data or content is “associated” with a thumbnail, or if a thumbnail is “associated” with data or content, then the data or content are said to be “paired” with the thumbnail.

“Personalization techniques” are any steps or actions which may be taken by a user to convert a wall that has been automatically generated by search criteria into a “personalized wall”. Non-limiting examples of personalization techniques include adding images that were not in an automated wall, deleting images from an automated wall, modifying images in an automated wall, changing the order of images within an automated wall, and converting the image from one kind of file to another kind of file.

“Personalized wall” is an Internet wall that has been created by the user's selection of particular thumbnail images to be included in the wall. When a wall has not been personalized at all, it is an “automated wall”.

“Publication of a wall” means sending the wall to a publicly stored server that may be accessed by the general public. For example, a person may send a file to Facebook™, and then others may later call up that file. Similarly, “to publish a wall” occurs when a user to takes actions to effect “publication” of that wall.

“Publication of associated content” means sending the data associated with a thumbnail advertisement of interest to a user, to a publicly stored server that may be accessed by the general public. Similarly, “to publish associated content” is for a user to take actions to effect “publication” of the associated content.

“Refining a data search” means adding to, deleting from, or modifying, some or all of the search terms or search techniques the user used to modify the results displayed from an initial data search. This term is related to, but not the same as, “modifying a data search”.

“Search techniques” are techniques which the user may use to search data sources in regard to a specific topic. Such techniques include, but without limitation, Boolean word search, semantic analysis, preference search based on prior searches, or preference search based on user ranking.

“Superimposing files” is the process by which a file of any type is imposed upon a previously existing file. For example, if there is a visual file, the addition of a new visual thumbnail or other visual material to the existing visual file is superimposing the new thumbnail or material on the existing file. When multiple thumbnails or other materials are added to a pre-existing file, there has been “superimposition of multiple files”. Note that the files, existing and superimposed, do not need to be of the same type. For example, in a pre-existing visual file, it is possible to add a new audio file.

“Thumbnail image” is minimized electronic image of any information. Some examples of such information are a picture, a word document, a spreadsheet, a banner, or a graph. Each represents an electronic content file. Some examples of such electronic content files are documents, compressed files, audio files, video files, Web pages, and Internet walls.

“Usage flow” is a process by which an Internet wall is created or manipulated. The Internet wall may be fully automated from one or more search sites, or may be a personalized wall. Manipulation of the wall includes any acts that alter the form or function of the wall. Some examples of acts of manipulation to an existing wall include adding images, deleting images, modifying images, changing the order of images within the wall, converting the image from one kind of file to another kind of file, storing the image locally, storing the image on a remote site, posting the wall to a Web site, or sending the Wall electronically to a third party.

“User Interest File” is a memory file that may be created that will include statistics related to the user's interest in various thumbnail images and associated advertising content, according to various measurements that may be taken of the user's interest.

“Wall within a wall” is an Internet wall which itself has become one thumbnail image within another wall.

### DESCRIPTION OF THE RELATED ART

The presentation of multiple options for viewing electronic files, in which the user selects a specific option by selected a related banner, have existed at least as long as the Internet, that is, since the 1990's or earlier. In recent years, applications have arisen in which the user receives a display of multiple icons on a computer screen, and indicates interest in a particular item by selecting on the related icon. Wireless telephones, such as the iPhone™ of the Blackberry™, use icons to represent files or information. Users select the icon to receive the related information.

The general approach of presenting multiple options on a screen was extended by automated creation of thumbnail walls exists. One example of such automated creation of thumbnail walls is the 3D Internet wall appearing on the Web site www.cooliris.corn. This Web site allows the user to perform a word search of a topic, and then presents the results in a moving 3D Internet wall of thumbnail images. The user may then click on an image to receive an automated link to the Web site represented by the thumbnail image or to the other electronic content file represented by the thumbnail image.

Advancement of the art requires additional refinements and extensions. Exemplary embodiments of the current invention will let the user, among other things, search for information using many criteria other than Boolean word searches, create a personalized wall, improve a personalized wall by adding or deleting or modifying content, create a wall within a wall, superimpose multiple files in one image or one audio stream, and choose among a variety of means for storing or forwarding a wall.

### SUMMARY OF EXEMPLARY EMBODIMENTS OF THE INVENTION

Exemplary embodiments of the present invention provide the above-mentioned refinements and extensions, among other things. According to one embodiment, searching for information may be done not only by written word or phrase subject to Boolean logic, but also by voice command, or by pre-defined criteria (which may be of any type, visual or audio, word or number or graphic).

According to one exemplary embodiment, a user may create a personalized wall by selecting various thumbnails, or by creating his or her own thumbnails, and by placing any such thumbnails in a wall designed by the user. According to various exemplary embodiments, the user may improve a previously created personalized wall.

According to one exemplary embodiment, the user may create a wall within a wall. According to one exemplary embodiment, the user may improve a wall within a wall by improving the enclosing wall, or by improving the enclosed wall, or by improving both the enclosing and the enclosed walls.

According to one exemplary embodiment, after the user has selected one thumbnail and viewed or heard the associated content, the user may superimpose additional material on the viewed or heard content. In the case of an image, the user may introduce multiple images onto the image associated with the selected thumbnail; such multiple images may be thumbnails or other images. In the case of an audio file, the user may introduce additional sounds to the audio file associated with the selected image. According to one embodiment, the user may introduce both images and sounds onto one file associated with a selected thumbnail.

According to one exemplary embodiment, the user may choose and execute any of a variety of means for storing or forwarding a wall, whether the wall is an automated wall or a personalized wall. Some non-limiting examples of storage include storing a wall on a local PC, storing a wall on a server or other storage device on a private system, or storing the wall with an ISP or other public server. Some non-limiting examples of forwarding a wall include posting the wall to a public forum such as Facebook™, or emailing the wall to a third party.

According to one exemplary embodiment of this present invention, it is possible to electronically create and transfer images that have three levels protection against electronic viruses.

### BRIEF DESCRIPTION OF THE DRAWINGS

Various other objects, features, and attendant advantages of exemplary embodiments of the present invention will become fully appreciated as the same become better understood when considered in conjunction with the accompanying detailed description, the appended claims, and the accompanying drawings, in which:

FIG. 1 is an example of a meshup.

FIG. 2 is an example of a meshup in which the content searched is a private database.

FIG. 3 is an example of a meshup in which the movement of the wall has made it appear at an angle to the vision of the user.

FIG. 4 is an example of a meshup in which a variety of thumbnails refer to several of the file types that may be represented as thumbnails in a wall.

FIG. 5 is an example of a wall with a media file. The media file may be video only, audio only, or both video and audio. In addition, it is possible to superimpose multiple media files onto the existing media file, as in, for example, the addition of multiple video files to one audio file, or for example, in the addition of two or more audio files to one video file.

FIGS. 6A and 6B are depictions of a general system on which the method may be operated according to an exemplary embodiment of the present invention.

FIGS. 7A and 7B are examples of a computer or consumer device employed by the user to execute various exemplary embodiments of the invention.

FIG. 8 is an example of possible steps in an exemplary method in which a wall is automatically created by a data search.

FIG. 9 is an example of possible steps in an exemplary method in which a personalized wall is created.

FIG. 10 is an example of possible steps in which a previously created wall (whether automatic or personalized) is modified.

FIG. 11 depicts some examples of storing and forwarding of created walls.

FIG. 12 is an exemplary method for deleting content from a pre-existing wall.

FIG. 13 is an exemplary method for adding content to a pre-existing wall.

FIG. 14 is an example of a wall within wall.

FIG. 15 is an example of a method for electronically creating and transferring images with multiple levels of protection against electronic viruses.

FIG. 16 is an example of a method in which information which was previously cleaned and stored is now requested by a party.

### DETAILED DESCRIPTION OF THE EXEMPLARY EMBODIMENTS

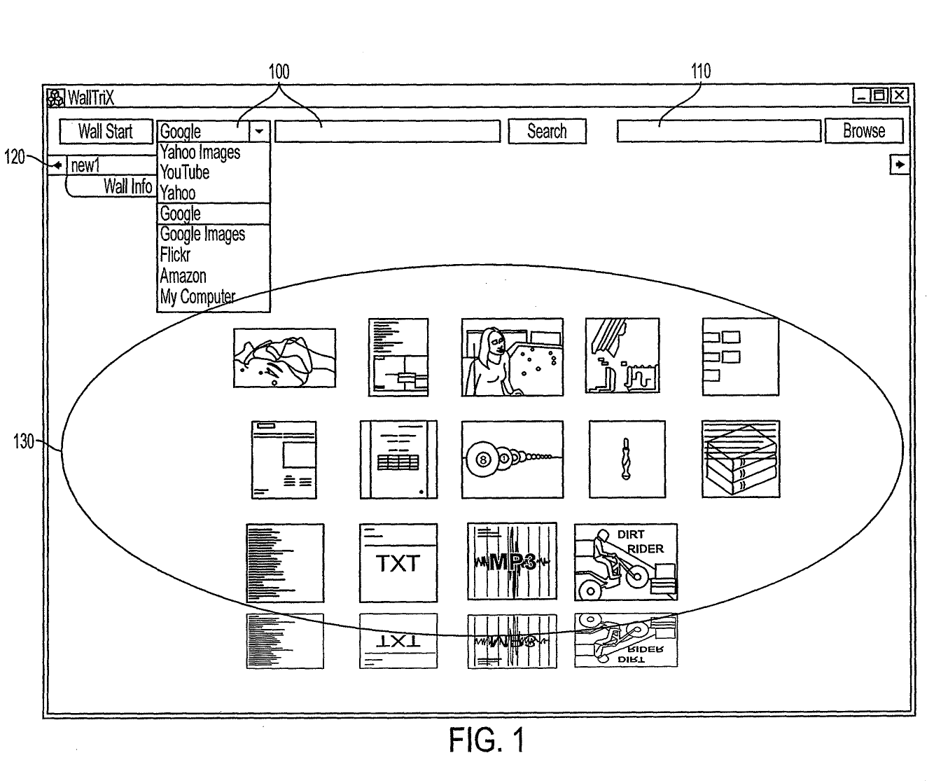

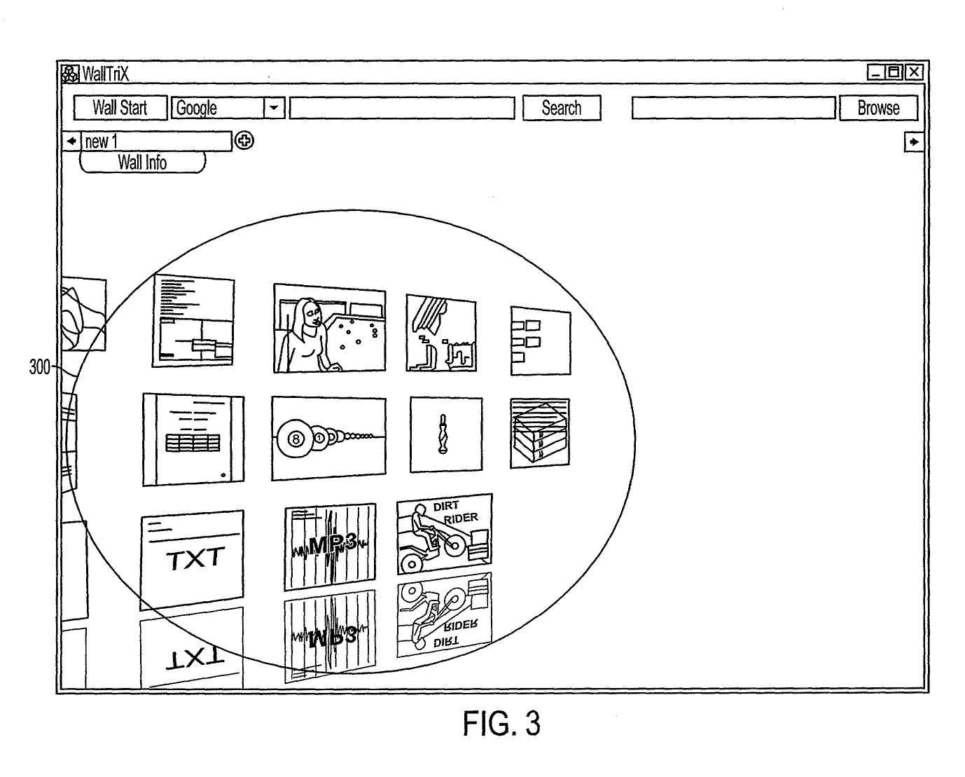

Some components of a meshup are shows in FIG. 1. The names of search engines utilized in a search are shown in 100. In this figure, the search engine utilized is Google™, but any search engines could be used. The user may search the engines according to a search term using Boolean logic, semantic analysis, or other search process. 110 shows a space on which a user may enter a web site or other URL address. The site or address entered by the user will be searched through the selected search engine or engines from 100. When the site or address is found, it will be displayed as a rectangle in 120. The user may then enter words or symbols on one or more of the rectangles in 120, and the results will be shown in the meshup 130. The results will be a plurality of thumbnails, as shown in 130. In FIG. 1, there are 14 thumbnails, but that number is not essential, and any plurality of thumbnails may appear. The thumbnails indicate a variety of file types, which is a feature discussed below in FIG. 3. The wall itself may appear directly facing the user, or at a slight angle as show in FIG. 1, or at a more acute angle. Each of the multiple rectangles in 120 may be a separate search, unrelated to the others. Alternatively, multiple terms may be used in 120, representing either a combined search conducted in multiple stages, or a single search in which the user enters all the terms at one time.

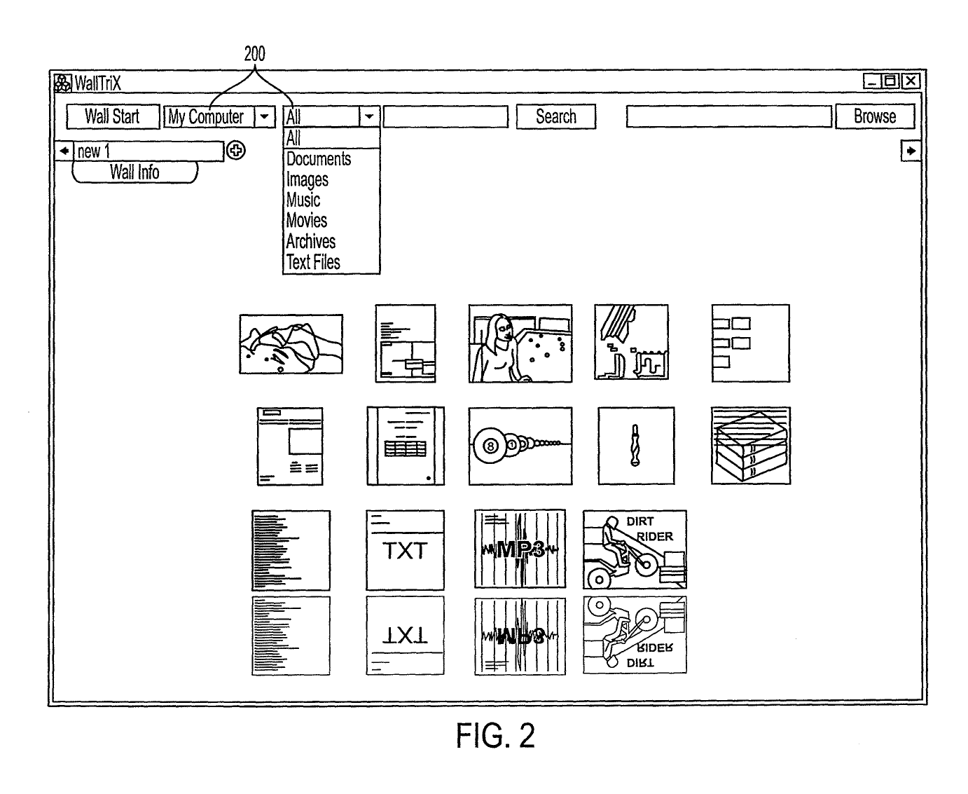

FIG. 2 shows some of the same features as in FIG. 1, but modified to show that that a different source of data may be searched. 200 shows that the search will be conducted on both the local computer, called here “My Computer”. “All” shows the type of files that will be searched from the local computer or local database, which might be, for example, video, audio, documents, images, etc. Here, the word “All” in 200 indicates that all files in the local computer or local database will be searched. It is possible also, according to one embodiment, to execute a search of both parts of the local computer or local database, and search engines.

FIG. 3 is an example of a meshup in which the wall is at a significant angle to the vision of the user 300. Note that if FIG. 2 and FIG. 3 appear in one display (such as a PC screen) in a seriatim manner, the visual effect will be to show a meshup that is changing its angle relative to the vision of the user. This may be done by showing a full frontal image of the wall, then shifting the angle of vision as though the screen were presenting a moving picture of the wall. The wall may be rotated to either side, or up, or down, in accordance with the user's preference.

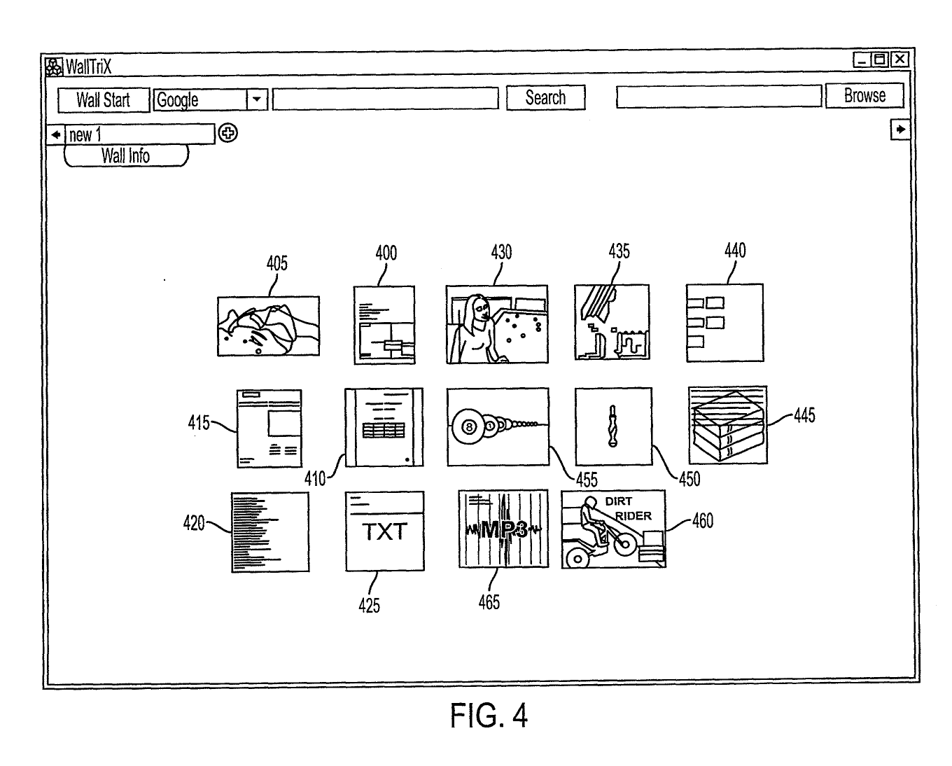

FIG. 4 is an example of a meshup in which a variety of thumbnails refer to several of the file types that may be represented as thumbnails in a wall. Fourteen file types are shown in FIG. 4, but these are representative only, as any file type may be depicted in a thumbnail. The file types shown include the following:

400 is a Word file.

405 is an image from a local computer or local database.

410 is a pdf of a PowerPoint™ presentation. Any other pdf file may be depicted. A PowerPoint™ file that is not coded as a pdf file may also be depicted.

415 is a Web site.

420 is a spreadsheet, here in Excel™, but the spreadsheet may be in any other format as well.

425 is a text file.

430 is flash video.

435 is an icon image.

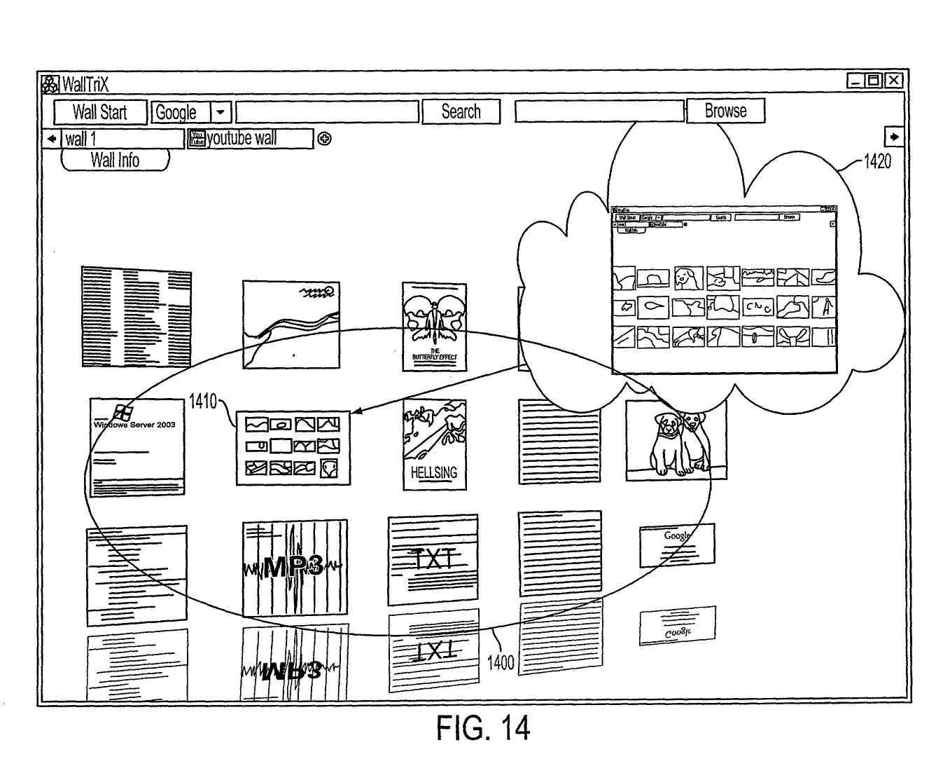

440 is a thumbnail representing a wall within a wall. The feature known as a wall within a wall is discussed in relation to FIG. 14 below. For now, it may be noted that an enclosed wall may be a thumbnail of a wall that was automatically generated by a search engine, in which case the enclosed wall was taken from one of the search engines in the list of search engines utilized for the search. Alternatively, the enclosed wall may be a personalized wall that was generated by the user or some other private party. In that case, the enclosed wall would have been taken from storage (such as, for example, the user's PC, or a corporate database, or the database of an Internet Service Provider, or the database of a company that hosts walls in the same way that Google, for example, hosts “gmail.com”).

445 is the decompressed image of a compressed file.

450 is a thumbnail representing a video file, which may be a still photograph (such as, but not limited to, a JPEG file), or a series of photographs appearing as a moving picture (such as, but not limited to, an MPEG file).

455 is an online image.

460 is a flash application, in this case of a game.

465 is a thumbnail representing an audio file, here in MP3 format. It should be understood that the file may be in any digital audio encoding format, not necessarily MP3, or even in an analog audio encoding format.

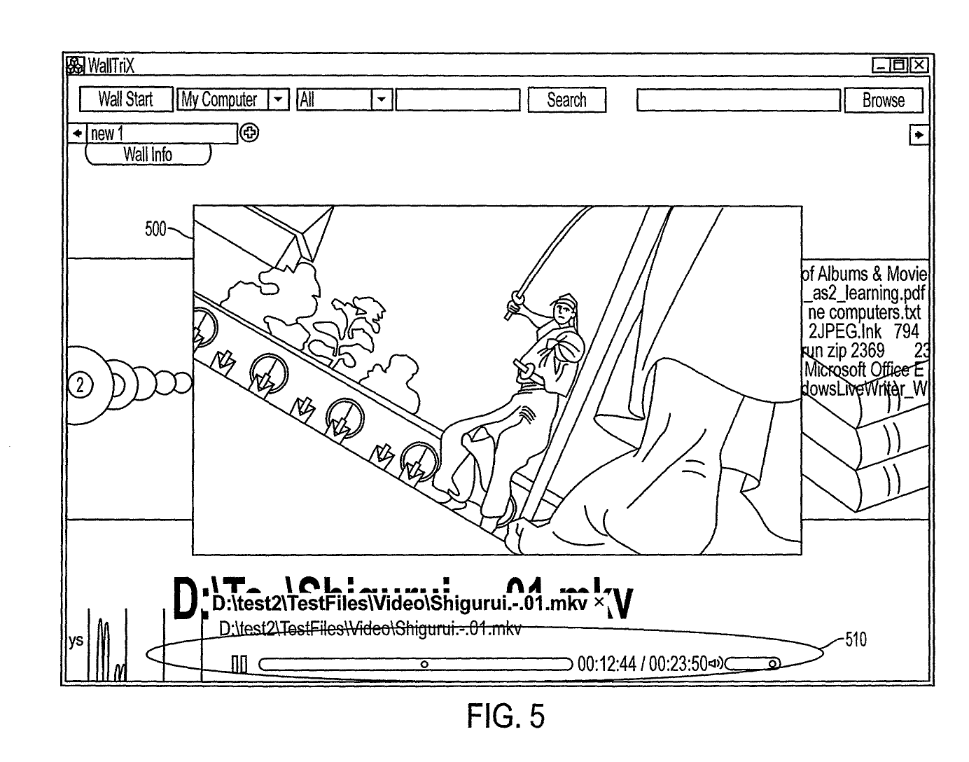

FIG. 5 is an example of a wall with a media file. The media file may be video only, audio only, or both video and audio. In addition, it is possible to superimpose multiple media files onto the existing media file, as in, for example, the addition of multiple video files to one audio file, or for example, in the addition of two or more audio files to one video file. In FIG. 5, 500 is a moving image of a media file, here called “media playback”, and 510 is a media control image, here called “media controls”, which allows the user to control such parameters as the place in the media displayed and the sound volume. In FIG. 5, one media playback is shown, here in a blownup fashion. It is possible to have multiple video files, that is to say, multiple media playbacks, playing at one time. If there are multiple playbacks simultaneously, it is possible to show a blownup image of one, or more than one, or all, of the media playbacks at the same time. Similarly, if there is an audio file associated with the video file, it is possible to have multiple audio files playing at the same time, in which each audio file may be controlled through a media control such as demonstrated in 510. Alternatively, if one or more of the files playing are audio only files (without video), it is possible to control any such audio file through a media control such as demonstrated in 510. It is further possible to play audio only files (without video files), in which case again each audio file may be controlled by a media control such as demonstrated in 510. If one electronic device is playing multiple files at a time, whether the files are audio or video or combined audio-video, it is possible to selectively channel only a subset of such files to one or more users. For example, if three audio-video files are playing simultaneously, plus a four file that is video only, plus a fifth file that is audio only, any user could tap into a subset of the five files playing simultaneously. This might be done, for example, by means a hardwire USB connection to the displaying device, in which each user has his or her own USB connection, and each user can control which files will play on a particular display dedicated only to that user. Or this might be by way of a different physical medium, as for example, short-range radio, in which each user has his or her own short-range frequency from the electronic device which is displaying all the files to the particular user's own display device on which the user has selected only the files of interest.

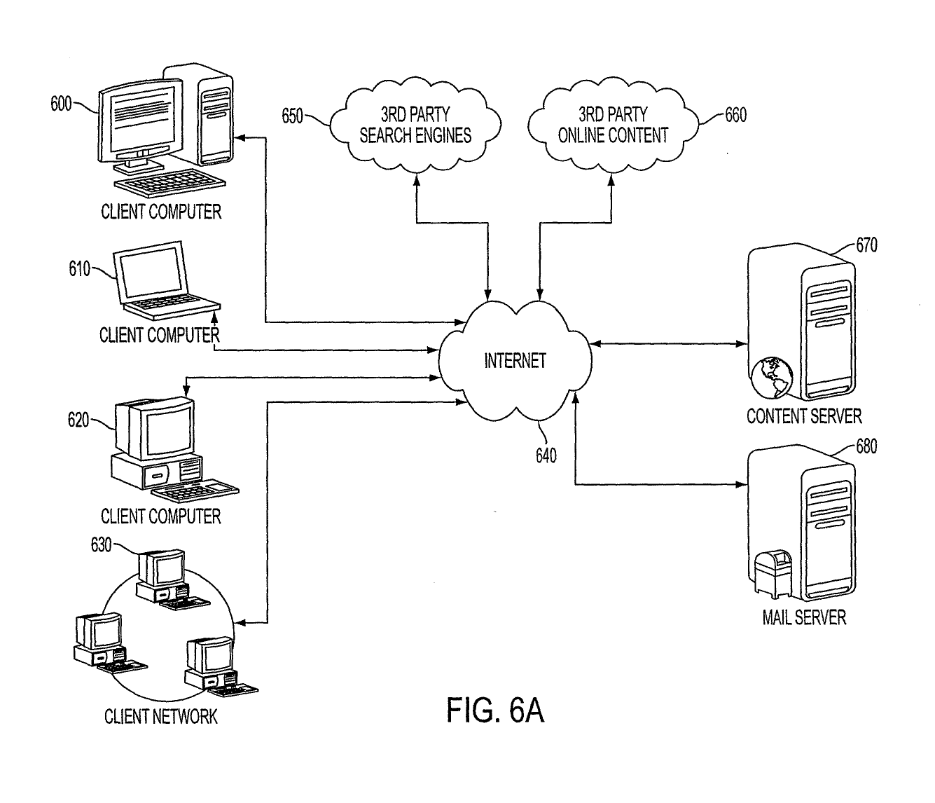

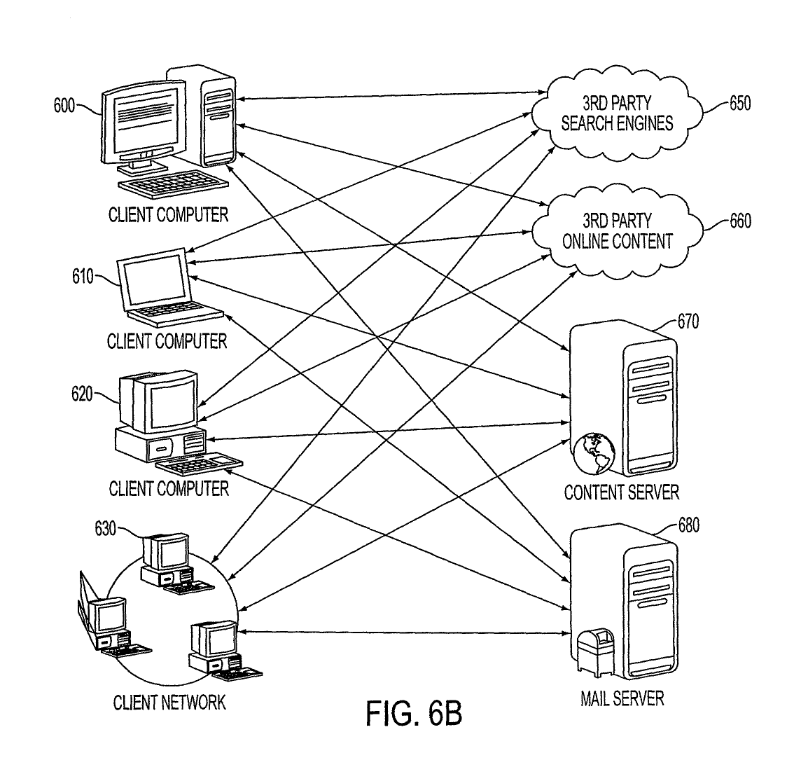

FIG. 6A is a depiction of an exemplary general system on which an exemplary method may be operated. Various kinds of input media, demonstrated at the left in elements 600-630, are representative of any kind of electronic input. Different configurations of computers are depicted in 600, 610, and 620. 630 depicts a network of computers, each computer of which may be any kind of configuration. All of the input media connect directly to the Internet, 640. From the Internet, connection is possible to a variety of information sources. Non-limiting examples of such information sources include 3^{rd} party search engines 650, 3^{rd} party online content 660, content servers 670, and mail servers 680.

FIG. 6B shows the same structural elements as in FIG. 6A, but connected in a different manner. In FIG. 6B, there are direct connections between elements on the left, 610-630, and the sources of information represented in elements 650-680. FIG. 6B thus shows that any client computer or client network, in any configuration, may be directly connected, without the Internet, to any source of information external to the client computer or client network.

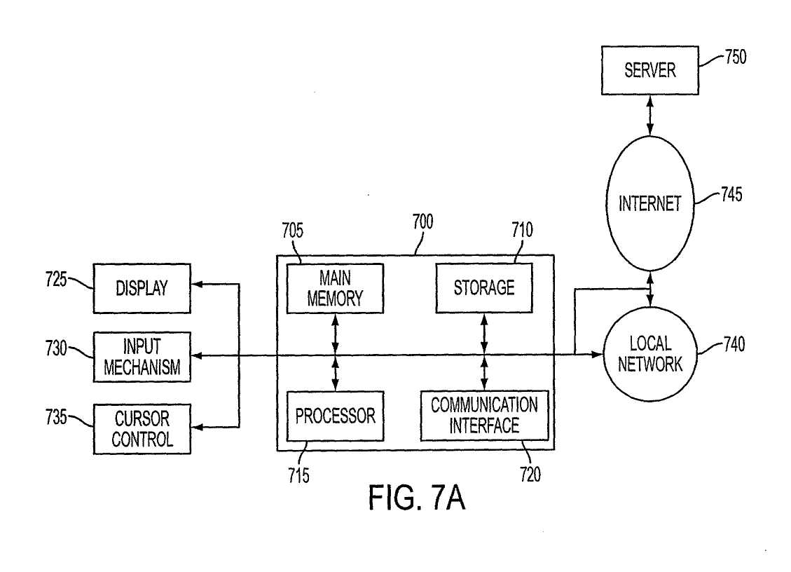

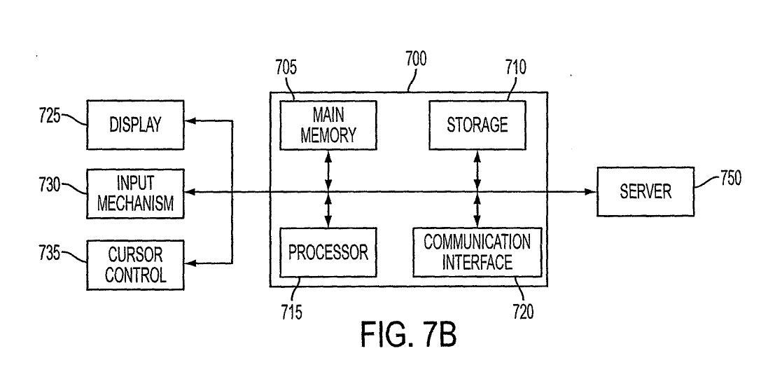

FIG. 7A is a diagrammatic example of a computer or consumer display electronic device employed by the user to execute various exemplary embodiments of the invention. The main processing, storage, and communication unit is depicted in 700. This main unit is composed of various modules, including the device's internal memory, called “main memory” 705, which is typically, but not exclusively and not necessarily, RAM. Main memory may be supplemented by non-main memory, often in the form of mass storage devices, such as disk drives, and depicted in FIG. 7 as “storage” 710. Information is processed in the processor 715, and data and/or results are communicated to and from the computer or electronic device via the communication interface 720. The user may interact with the computer or electronic device in a variety of ways, some of which are depicted in 725, 730, and 735. These include, but not in a limiting way, a display 725 (which may be visual or audio or other information), an input mechanism 730 for the user to input data (which may be visual or auditory or other data), and a cursor control 735 or other means of maintaining contact between the user and the computer or electronic device. The computer or electronic device connects to a local network 740, which connects to the Internet (possibly through an Internet Service Provider) 745, which connects to a server 755.

FIG. 7B contains many of the same elements as FIG. 7A, but with a different interface to the outside world. Elements 700-735 have already been described in FIG. 7A, but in FIG. 7B, the communication interface 720 connects directly to server 750, without an intermediate connection to a local network or the Internet. It should be understood that different interfaces are also possible. It would be possible, for example, for communication interface 720 to connect to the local network 740 from FIG. 7A, and then from 740 to the server 750. It would be possible, for example, for communication interface 720 to connect directly to the Internet 745 from FIG. 7A, and then from 745 to the server 750.

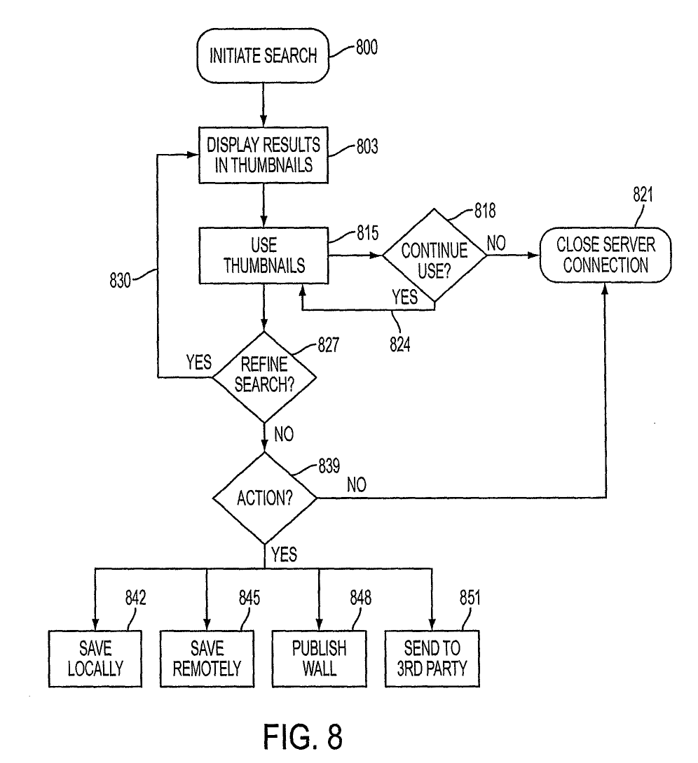

FIG. 8 is an example of possible steps in an exemplary method in which a wall is automatically created by the data search. In 800, a search is initiated by the user opening a link to a data source, or multiple links to multiple data sources. The user employs search techniques which result in a thumbnail wall display 803. The user may then reviews and uses the thumbnails 815. At this point, the user may continue to use the thumbnails 818. “Use” of the thumbnails means to select one or more thumbnails (by clicking them or otherwise selecting them), automatically downloading the content paired with each selected thumbnail, and using the data as the user sees fit. After an initial use, the user must decide whether to continue using the thumbnails displayed and paired content 818. If not, the server connection to the data sources or sources is severed 821. At 815, the user may decide that the thumbnails displayed are not sufficient. If so, the user will first return, 824, to the original wall at 815. The use will then proceed to refine the search 827. The user refines the search 827 by adding to, deleting from, or modifying, some or all of the search terms or search techniques the user used to generate the initial display 803. For example, if the user is using Boolean logic with a word search, the user may change the words that are being used to create the search. When the modified search is performed, a new display 803 is automatically generated. The process is reiterated until the user has created a desired wall and used the data as the user requires.

If the search is refined 830, then the new results are displayed 803, and the process continues. After the final display has been generated through the final iteration of 830, and the paired data has been used as desired, the user must decide whether or not to take an action 839. If not, then the current connection to the data sources is severed 821. If so, then the user must decide what action to take. The four possible actions are to save the wall to a local computer or local storage device 842, to save the wall to a remote computer or remote storage device 845, to publish the wall 848, or to send the wall to a third party 851. The user may execute any one of these four actions, or any combination of them, but each action selected must be executed by the user, either manually or according to automatic preferences that the user has programmed into the system.

As discussed previously in regard to FIG. 5, multiple users can access a device displaying multiple files simultaneously. If that occurs, then each user will have the options presented in FIG. 8, and therefore each user may create, use, and store or send, an Internet wall, according to the options discussed in regard to FIG. 8.

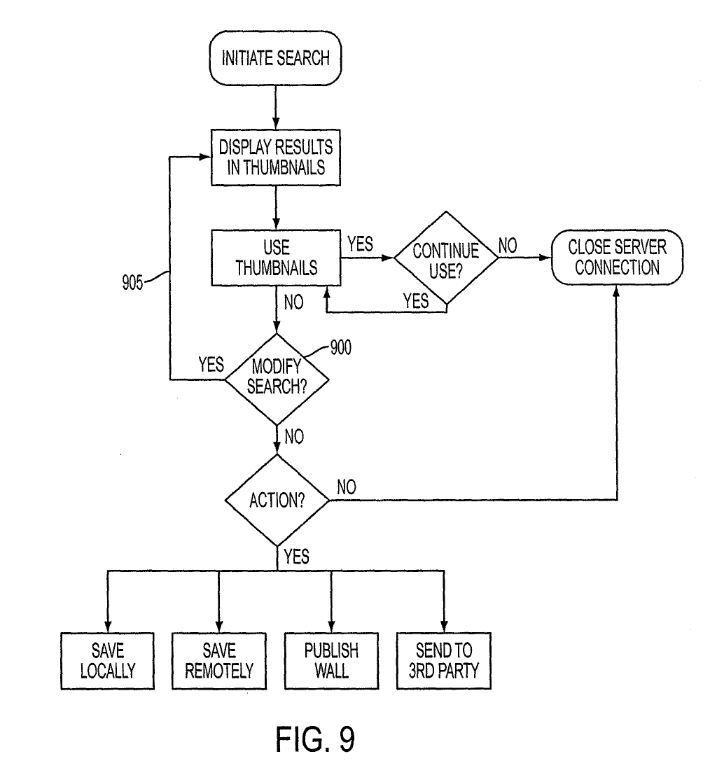

FIG. 9 is an example of possible steps in an exemplary method in which a personalized wall is created. The steps in FIG. 9 are the same as the steps in FIG. 8, with one important difference. Step 827, refine the search, has now been replaced by step 900, modify the search. Therefore, 827 and 830 from FIG. 8 do not appear in FIG. 9, but are replaced by 900 and 910, respectively.

To “modify the search” 900 includes two kinds of possible actions which the user may execute. First, in 900, as in 827, the user may or may not add to, delete some of, or modify, the initial search techniques. Second, to create a personalized wall, the user must use at least one of a variety of personalization techniques in 900. The user may also use two or more such personalization techniques, but must at a minimum use at least one such technique to create a personalized wall.

The user will access data from one or more data sources to generate display results in 900. When the user has finished all modifications of the search, he or she will continue to steps 839-851, as explained with regard to FIG. 8. Until then, the user will continue to modify the search 905 iteratively, until a final satisfactory search result has been achieved in 900. In 900-905, the user may add more thumbnails or more thumbnail/content pairs to an existing wall, or may delete one more thumbnail/content pairs from an existing wall, or may reorder the thumbnail images in an existing wall by any number of actions. Non-limiting examples of data sources include data from the Internet, data from a privately stored database, and data from a database created by the user who is building the personalized wall (in which the user's database may be stored permanently or may be a temporary file that ends when the user severs connection with the server). Non-limiting examples of actions to reorder thumbnail images include placing a new thumbnail image at a particular position by rank and file, deleting an existing thumbnail image from a particular position by rank and file, creating a new rank in the thumbnail wall, creating a new file in a thumbnail wall, or any combination of the foregoing. Thumbnail images displaced by the insertion or deletion of thumbnail images at particular rank and file positions may be placed by the user anywhere in the wall, or may be move by some rule selected by the user (such as, for example, when a new image is added, move all subsequent images in that rank one position to the right).The result of employing one or more personalization techniques will be to create a wall that has been personalized by the user. The result is that the wall will be personalized in FIG. 9, rather than an automated wall as shown in FIG. 8.

As discussed previously in regard to FIG. 5, multiple users can access a device displaying multiple files simultaneously. If that occurs, then each user will have the options presented in FIG. 9, and therefore each user may create, use, and store or send, an Internet wall, according to the options discussed in regard to FIG. 9.

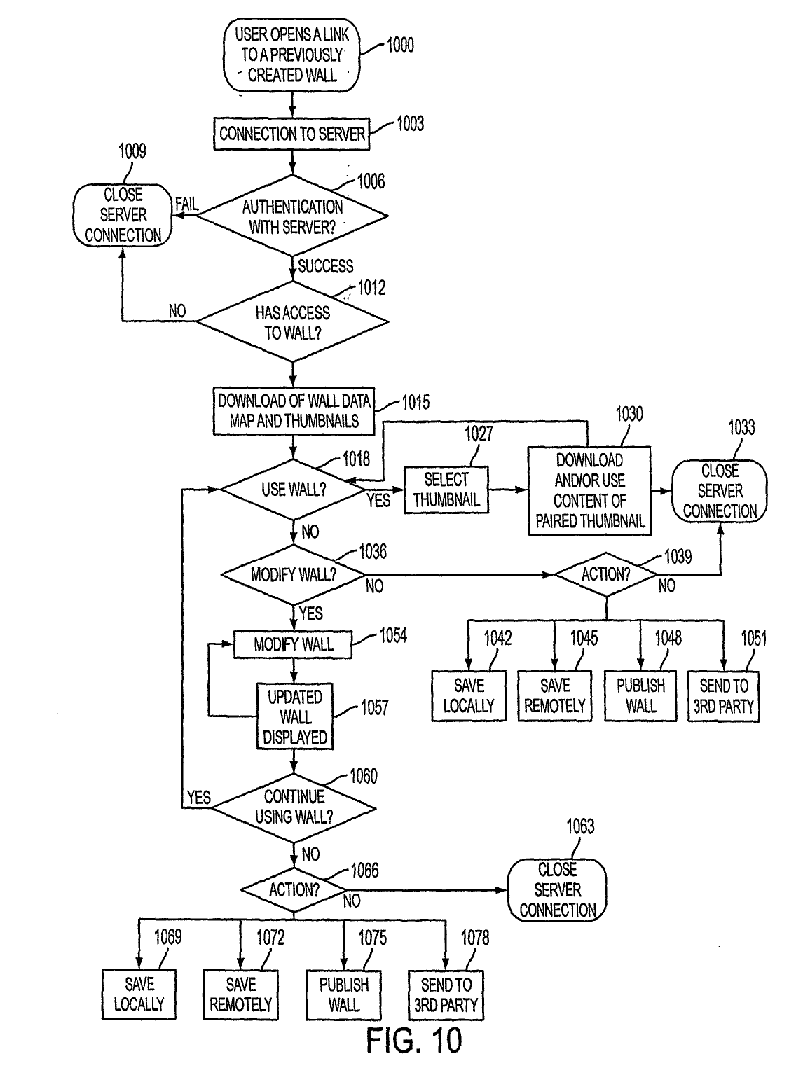

FIG. 10 is an example of possible steps in which a previously created wall (whether automated or personalized) is called up by the user. The user may then use and/or modify the previously created wall. In 1000, the user gets a link to a previously created wall (which may also be called either a “previously existing wall” or an “existing wall”). The user connects to a server 1003, which will authenticate that user 1006. If the authentication fails, then the current connection to the server is severed 1009. If the authentication succeeds, then the user asks for the existing wall 1012. If the user is unable to access the existing wall, then the server connection will be closed 1009. Typically, however, after confirmed access, the user will access to the wall, and the user will then download to his or her computer the data map for the requested wall and the individual thumbnails in the wall 1015. When the existing wall and its thumbnails are displaced, the user must decide whether to use or modify the wall 1018. If the user decides to use the wall, then the user will select the desired thumbnails 1027, download and/or used the paired content 1030, and continue this process 1018-1030 iteratively until he or she either decides to modify the wall in 1036, no longer needs the wall in which case the connection to the server is closed 1033.

At 1018, the user may decide not to use the wall further. If so, the user must decide whether or not to modify the wall. If not, then user must decide whether to perform an action 1039. If not, then the server connection is closed 1033. If so, then the user must decide what action or actions to take. The user may save the wall to a local server 1042, or save it to a remote server 1045, or publish it 1048, or send it to a third party 1051. The user may perform any or all of these four actions.

If at 1036 the user decides to modify the existing wall, then he or she will do so 1054. To modify the wall, the user in 1054 uses one or more of the personalization techniques discussed above in regard to steps 900-5 in FIG. 9. Each time the user modifies the existing wall, the user will see a new display 1057, and this process through 1054 and 1057 will continue until the user has obtained the desired display. Further, in 1054 the user may, but is not required to, change one or more of the search techniques which were used to create the existing wall. Again, every time a search technique is changed, a new display 1057 is created, and there is an iterative process between 1054 and 1057 until an acceptable is obtained. Once an acceptable display is obtained, the user must decide what to do with the display and in particular whether to continue using the wall 1060. The user may decide to continue using the wall, in which case there will be a reiteration of steps 1018-1060, until the user is satisfied with the wall in 1060 or the server connection is closed in 1033. If the user is satisfied with the final display in 1060, then the user will not continue using the wall, but will decide at 1066 whether or not to take an action in regard to the displayed wall. If the user decides not to take a further action, then the server connection will be closed 1063. Alternatively, the user may decide to take an action, but if so, then the user must decide which action 1066. The four possible actions are to save to a local server 1069, to save to a remote server 1072, to publish 1075, or to send to a third party 1078. The user may decide to perform any or all of these four actions.

As discussed previously in regard to FIG. 5, multiple users can access a device displaying multiple files simultaneously. If that occurs, then each user will have the options presented in FIG. 10, and therefore each user may create, use, and store or send, an Internet wall, according to the options discussed in regard to FIG. 10. In this case, each user is accessing a wall created previously either by that user, or by another user. It is also possible for different users to access the same general device, playing multiple files at the same time, in which one or more of the files are previously created Internet thumbnail walls, and one or more of the files are Internet thumbnail walls being generated online by the user. Whether the walls were previously created, or being generated online, they may be audio or video or audio-video, or any kind of electronic data type, and stored in any manner (that is, locally, or to a remote server, or to a public database).

It should be understood from FIGS. 8, 9, and 10, taken as a group, that any combination of creation, usage, modification, refinement, storage, publication, and sending, of walls is possible, including, but without limitation, any of the following:

(1) Creation and usage of an automated wall, followed by local storage of an automated wall (with or without refining the search in 827);

(2) Creation and usage of an automated wall, followed by storage at a remote server of an automated wall (with or without refining the search in 827);

(3) Creation of an automated wall, followed by publication of an automated wall, (with or without refining the search in 827);

(4) Creation of an automated wall, followed by sending an automated wall to a third party, (with or without refining the search in 827);

(5) Creation of a personalized wall, followed by local storage of a personalized wall (with one or more personalization techniques in 900-905);

(6) Creation of a personalized wall, followed by storage at a remote server of a personalized wall (with one or more personalization techniques in 900-905);

(7) Creation of a personalized wall, followed by publication of a personalized wall, (with one or more personalization techniques in 900-905);

(8) Creation of a personalized wall, followed by sending a personalized wall to a third party, (with one or more personalization techniques in 900-905);

(9) Calling up a previously created wall (whether automated or personalized), followed by local storage of the wall (whether or not the previously created wall was modified). The saving to local storage or may not be combined with the deletion of a previous storage. That is, the user may continue storage only of the previously created wall (whether that wall was stored locally or remotely), or may cause local storage of only a newly modified wall that was previously created, or may store the previously created wall (whether stored locally or remotely) and also locally store the newly modified wall that was previously created;

(10) Calling up a previously created wall (whether automated or personalized), followed by remote storage of the wall (whether or not the previously created wall was modified). The saving to remote storage or may not be combined with the deletion of a previous storage. That is, the user may continue storage only of the previously created wall (whether that wall was stored locally or remotely), or may cause remote storage of only a newly modified wall that was previously created, or may store the previously created wall (whether stored locally or remotely) and also remotely store the newly modified wall that was previously created;

(11) Calling up a previously created wall (whether automated or personalized, and whether stored locally or remotely), followed by publication of that wall (whether or not the previously created wall was modified, and of modified then whether or not modified wall is stored in any manner);

(12) Calling up a previously created wall (whether automated or personalized, and whether stored locally or remotely), followed by sending that wall to a third party (whether or not the previously created wall was modified, and if modified then whether or not the modified wall is stored in any manner.

As discussed previously in regards to FIG. 5, FIG. 8, FIG. 9, and FIG. 10, multiple users may access one general display simultaneously. Therefore, each of the options presented here, (1)-(12) in paragraphs 79-90, and any other possible users or functions of any of the alternative embodiments described in this specification, can be accessed and used by any one or of multiple users accessing one general display at the same time.

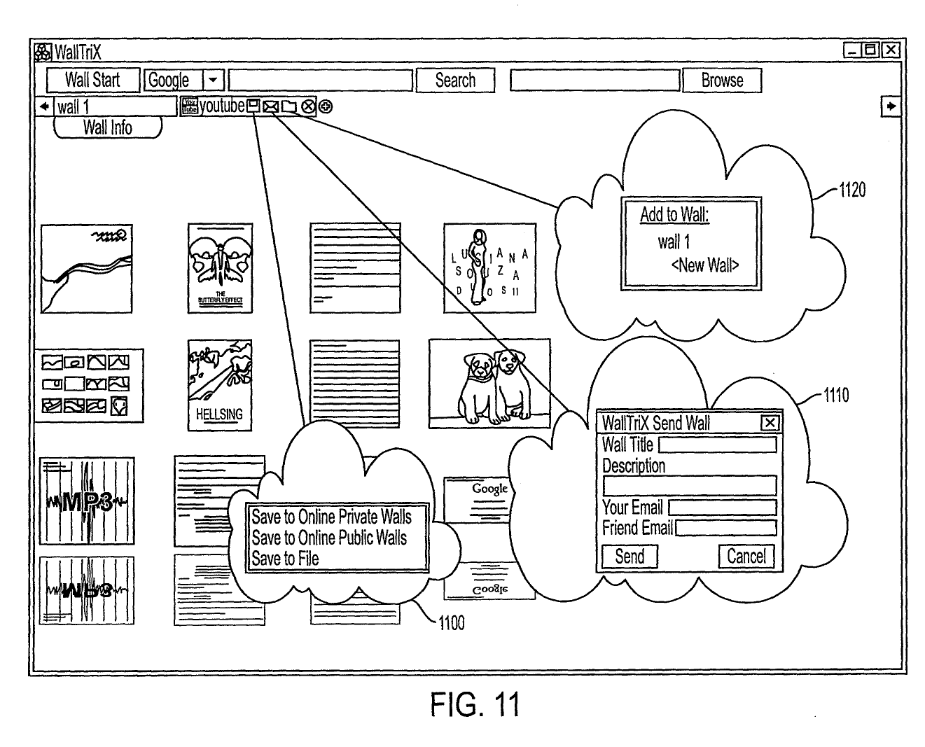

FIG. 11 depicts some examples of storing and forwarding of created walls. In 1100, some save options are demonstrated. In 1100, “Save to File” means to save locally, on the user's computer, with private access limited to the user. In 1100, “Save to OnLine Public Walls” means to save remotely to a service provider's server, with public access allowed. “Save to OnLine Private Walls” means to saver remotely to a service provider's server with private access only, or to save to a private server and again with private access only. In 1110, the user presses on the envelope symbol at the top left of FIG. 11, and can then send the wall as an email to a third party. Sending by email is exemplary only—the file may be sent by Skype, by publication to an electronic whiteboard, or by any other means. In 1120, the user is given an option to take the current wall and add it as a thumbnail to a pre-existing wall. An example of a wall embedded in an embedding wall is element 1420, which is discussed below in regard to FIG. 14. If the user chooses to embed a wall in 1120, the new wall will be saved or published as in 1100, or sent as in 1110. If multiple are users are using a general display at any time, each user may execute any part of the options presented in FIG. 11 and discussed here.

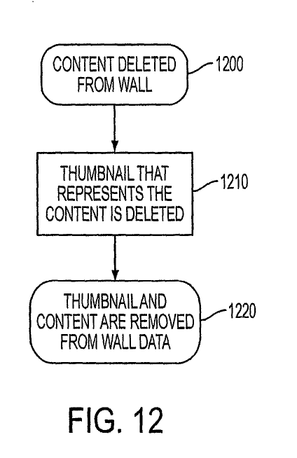

FIG. 12 is an exemplary method for deleting content from a pre-existing wall. The user selects a thumbnail representing certain content that the user wants deleted from the existing wall 1200. User deletes that thumbnail from the wall 1210. After the thumbnail has been deleted in 1210, the thumbnail and its associated content will be automatically deleted from the wall data 1220. The user may then save the modified wall. However, once the thumbnail has been deleted and the new wall has been saved, the associated content cannot be accessed through this wall. In addition to saving the modified wall (which may be either local saving or remote saving), the user may also choose to publish and/or send the modified wall. If multiple are users are using a general display at any time, each user may execute any part of the method presented in FIG. 12 and discussed here.

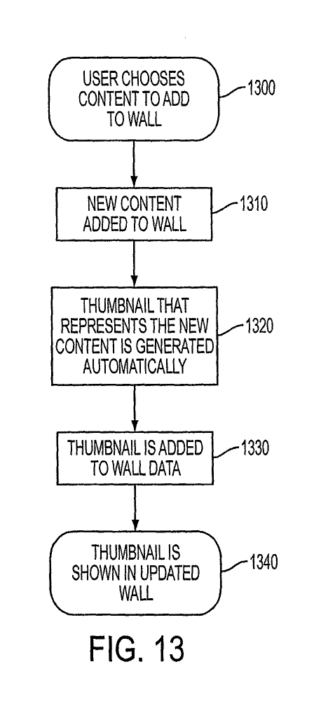

FIG. 13 is an exemplary method for adding content to a pre-existing wall. First, the user must define content that he or she wants add to the wall, 1300. This may be content that is found from on the Internet or from another source. Or it may be content that the user creates. Or it may be a combination of found and created content. The user then transfers the defined content to a pre-existing wall, possibly by dragging over, but also may be by any other method (such as, for example, by voice command, or by right click, or other) 1310. The system then generates a thumbnail of the defined content 1320 (including a link between the thumbnail and the paired content), and adds that thumbnail to the pre-existing wall 1330. The thumbnail will then be shown in the updated wall 1340. The user then has the previously discussed options of actions with the wall, including local storage, remote storage, publication, or sending to a third party. If multiple are users are using a general display at any time, each user may execute any part of the method presented in FIG. 13 and discussed here.

FIG. 14 is an example of a wall within wall. 1400 is a wall of thumbnail images. Within that wall 1400, 1410 is itself a wall of thumbnail images. Hence, FIG. 14 is a wall within wall, 1400 is an enclosing wall, and 1410 is an enclosed wall. 1420 is a blowup of 1410. In some exemplary embodiments, 1420 would not actually appear in the wall within wall. In other exemplary embodiments, 1420 would appear in the wall within wall, and at least one purpose of such a blowup would be to enable the user to more easily determine if he or she is interested in accessing the paired content associated with the thumbnail images in the enclosed wall. If the user is interested in such paired content, the user would first select that enclosed wall, and then select from the enclosed wall the thumbnail image or images of interest.

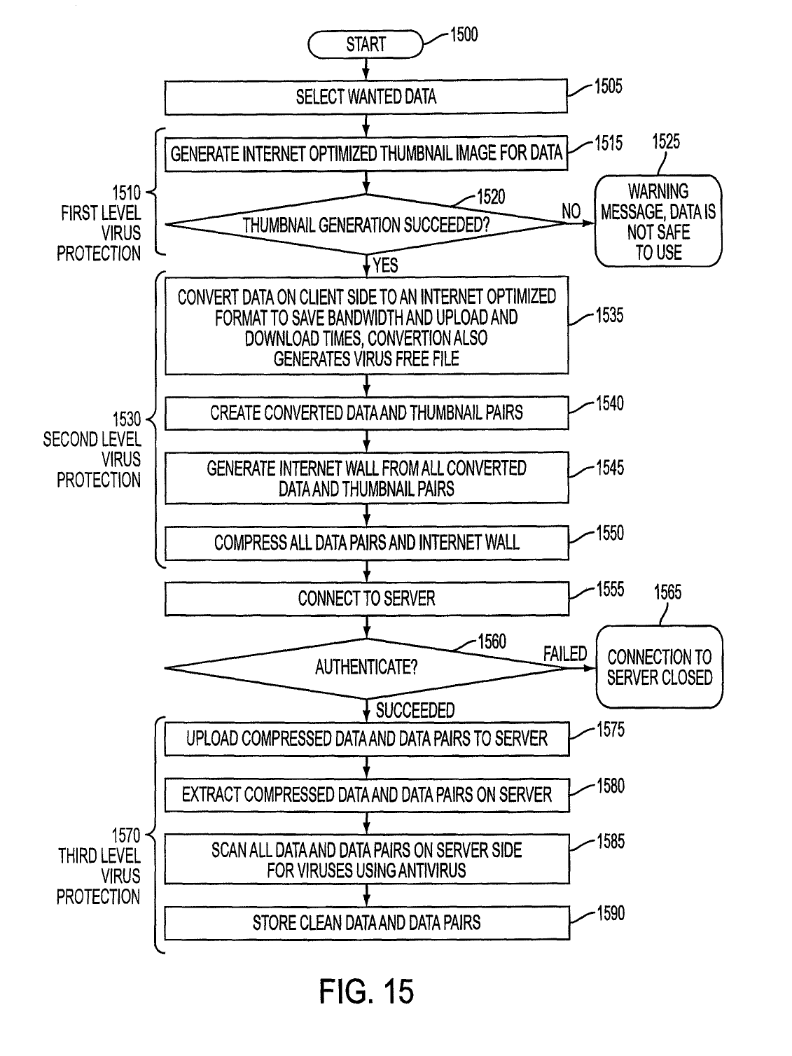

FIG. 15 is an example of a method for electronically creating and transferring images with multiple levels of protection against electronic viruses. In 1500, a user starts the method by opening a computer connection with one or more electronic sources of information. The user then selects a particular piece or set of data 1505. The exemplary method then enters the first level of virus protection 1510, which comprises three steps 1515, 1520, and 1525. In 1515, the user generates a thumbnail image for the data. The thumbnail image may be, but is not required to be, in Internet optimized format. Generally, such a format allows a reduced bandwidth for communication, which reduces the communication time with between a user and a server, decreases upload and download times, decreases cost of transfer, and minimizes possible error of transfer. The generation of this thumbnail image either succeeds or fails 1520. If it fails 1525, that means that there may be something wrong with the data. For example, the data may be infected with a virus that does not permit the creation of a thumbnail linked to the data, or the data may simply be corrupted in some way. The exact nature of the problem might not be clear to the user, but in any case, the user's inability to generate a thumbnail for the associated paired data indicates a virus or other problem with that data, because the method of generating a paired thumbnail should proceed without problem if the data is not infected with a virus. 1525 may include an explicit (written or verbal) warning message that the data is not safe to use, or may instead by only an implicit warning from a clear failure to generate a thumbnail image.

If the thumbnail generation in 1520 succeeds, the exemplary method then enters the second level of virus protection 1530, which comprises the four steps 1535, 1540, 1545, and 1550. In 1535, the associated data is converted, at the user's computer, into an Internet optimized format. The success of the conversion to the Internet optimized format is a measure of freedom from virus, since a virus-infected file will not easily convert to an Internet optimized format. (If there is a part of the file that is not infected by a virus, that part may convert successfully, but the infected part will probably not convert successfully.) After the data has been converted in 1535, the generated thumbnail from 1520 and the converted data from 1535 are paired 1540. At this point, the system converts the thumbnails and associated data into an Internet wall 1545. The pairs will then be compressed further by any number of compression methods 1550.

In 1555, the user connects to a server for the purpose of storing the compressed data, thumbnails, and thumbnail/data pairs, on the server. The server must authenticate the user's identity and permission to access the server 1560. If authentication fails, the system will close the user's connection to server 1565. If authentication succeeds, the method will progress to the third level of virus protection 1570, which comprises the four steps 1575, 1580, 1585, and 1590. After successful authentication, compressed data and data pairs are uploaded to the server 1575. The uploaded materials are extracted on the server as either data or thumbnail/data pairs 1580. Using some kind of antivirus package, the server will then scan all the data and all the pairs to identify viruses, and to neutralize any found viruses if possible 1585. The server will then store all of data and thumbnail/data pairs that have been cleaned of viruses 1590. Data or pairs that could not be cleaned at 1585 will either be discarded or stored in quarantine within the server. It will be understood that if an Internet wall was created at 1545, then that wall will also be sent to the server in 1575, compressed in 1580, scanned in 1585, and stored in 1590.

The exemplary method depicted in FIG. 15 is executed in parts of the devices and system set forth in FIG. 7 and FIG. 6, respectfully. Steps 1500-1555 are executed in FIG. 7, elements 700-735. The same execution may be viewed in FIG. 6, in which steps 1500-1555 are executed on any of 600, 610, 620, or a user's computer in client network 630. Steps 1555-1590 are executed in parts of the devices and system set forth in FIG. 7 and FIG. 6, respectfully. In FIG. 7, these steps 1555-1590 are executed at the local server, which is part of the local network 740. The same execution may be viewed in FIG. 6, in which steps 1555-1590 are executed in a local server which is part of the client network 630. It is also possible to execute steps 1555-1590 on a public server, such as that portrayed in 670, or in 750. Step 1555 is part of both executions, because there is a connection between a client side device (such as a user's computer), hence the last of steps 1500-1555, and a local server, hence the first of steps 1555-1590.

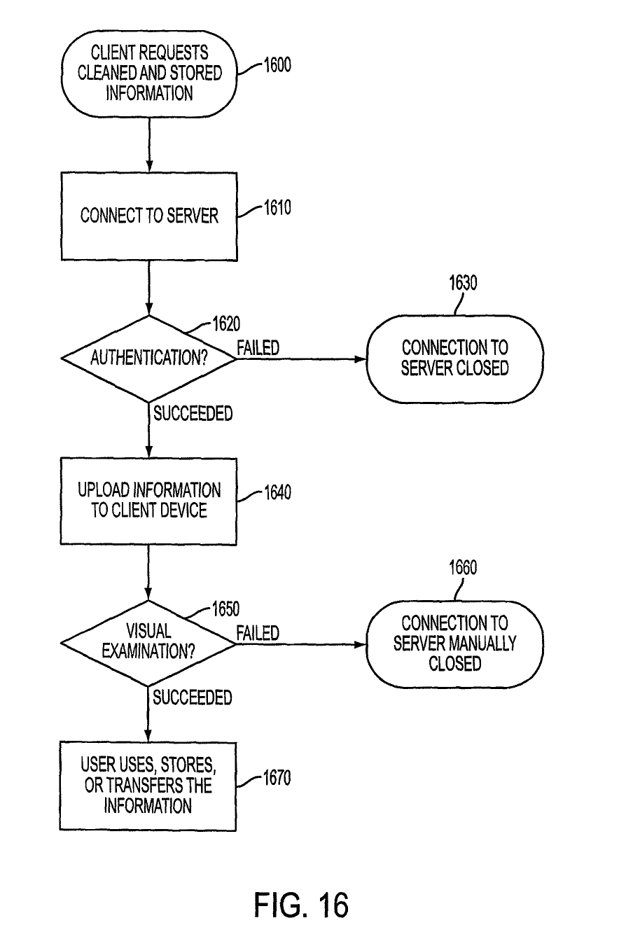

In FIG. 16, information (meaning data, or a thumbnail/data pair, or a thumbnail image wall) which has previously be cleaned and stored, culminating in 1590, is now requested by a party 1600. The requesting party may be the user who generated the information, or a third party. The requesting party may seek any information, meaning any or all of stored and cleaned data, or stored and cleaned thumbnail/data pair, or stored and cleaned thumbnail image wall, or any combination of the foregoing. The requesting party will seek connection to the server where the information is stored 1610. The system will try to authenticate the requester's identity and right to access the server 1620. If authentication fails, the connection between the requested and the server will be closed 1630. If authentication succeeds, then the requested will request certain information, the server will provide it, and the information will be uploaded to the requester's client device 1640. At this point, the requesting party will make a visual examination of the uploaded information 1650. If the requesting party deems the material to have failed a visual test, then the requesting party will closed the connection to the server 1660. If the requesting party deems the material to have passed the visual test, the requesting party will store or use the uploaded information 1670. There are many different possible criteria by which the requested information may be visually tested. Possible, but non-exclusive, testing criteria are the following:

Upon the requesting party's viewing the information, what is the relevance of the information to the requesting party? If the information appears irrelevant, then the requesting party will close the connection.

Upon the requesting party's viewing the information, what is the source of the information viewed? If the source is considered by the requesting party to be hostile or unknown, the requesting party may close the connection.

Are there any signs of file corruption in the images viewed by the requester? If so, the requesting party may close the connection.

If the requesting party uses antivirus software or another automated means of testing the images, whether the test is visual or otherwise, do the automated means detect a problem with an image? If so, the requesting party may close the connection.

If the uploaded information passes the requesting party's tests, the requesting party may use the data, download it, transfer it to a third party, or do some combination of the foregoing 1670.

The exemplary method depicted in FIG. 16 is executed in parts of the devices and system set forth in FIG. 7 and FIG. 6, respectfully. Steps related to a client device, including 1600-1610, and 1640-1670, are executed in FIG. 7, elements 700-735, or, if the requesting party is a third party rather than the user who created the device, in another client device such as a computer that has structural elements similar to those depicted in 700-735. The same execution may be viewed in FIG. 6, in which steps 1600-1610 and 1640-1670 are executed on any of 600, 610, 620, or a user's computer in client network 630. Steps related to a local server, including 1610-1640, are executed in parts of the devices and system set forth in FIG. 7 and FIG. 6, respectfully. In FIG. 7, these steps 1610-1640 are executed at the local server, which is part of the local network 740. The same execution may be viewed in FIG. 6, in which steps 1610-1640 are executed in a local server which is part of the client network 630. Steps 1610 and 1640 are part of both executions, because in each such step there is a connection between a client side device (such as a user's computer) and a local server.

The foregoing description of aspects of various exemplary embodiments of the present invention has been presented for purposes of illustration and description. It is not intended to be exhaustive or to limit the present invention to the precise form disclosed. Modifications and variations are possible in light of the above teachings, or may be acquired from practice of the present invention. The principles of the exemplary embodiments of the present invention and their practical applications were described in order to explain and to enable one skilled in the art to utilize the present invention in various embodiments and with various modifications as are suited to the particular use contemplated. Thus, while only certain aspects of the present invention have been specifically described herein, it will be apparent that numerous modifications may be made thereto without departing from the spirit and scope of the present invention.

What is claimed is:

1. A method for virus resistant image transfer, comprising:
a user opening a computer connection;
the user selecting data;
the user generating an Internet optimized thumbnail image associated with the selected data;
the user converting the selected data to an Internet optimized format;
the user creating an Internet optimized pair of the selected data and the thumbnail image;
the user compressing all Internet optimized pairs;
the user connecting to a server; and
authenticating the user by the server.

2. The method of claim 1, the method further comprising:
operation indicating that authentication of the user failed; and
closing the connection to the server .

3. The method of claim 1, the method further comprising:
the user uploading, to the server, the converted data, the Internet optimized thumbnail image, and the Internet optimized pair;
the user extracting the converted data, the Internet optimized thumbnail image, and the Internet optimized pair;
the user scanning for viruses the converted data, the Internet optimized thumbnail image, and the Internet optimized pair;
the system cleaning from viruses the scanned converted data, the Internet optimized thumbnail image, and the Internet optimized pair; and
the system storing the cleaned converted data, the Internet optimized thumbnail image, and the Internet optimized pair.

4. The method of claim 3, further comprising:
a client requesting stored scanned converted data, the Internet optimized thumbnail image, or the Internet optimized pair;
the client connecting to a server;
the server authenticating the client;
the client uploading the requested scanned converted data, Internet optimized thumbnail image, or Internet optimized pair, to a client device;
the client conducting an examination of the uploaded scanned converted data, the Internet optimized thumbnail image, or Internet optimized pair;
if the examination is successful, the client storing, using, or transferring the requested scanned converted data, the Internet optimized thumbnail image, or the Internet optimized pair; and
if the examination is not successful, the user closing the connection to the server.

5. The method of claim 4, in which the examination comprises the user viewing the requested scanned converted data, the Internet optimized thumbnail image, or the Internet optimized pair, for relevance.

6. The method of claim 4, in which the test examination comprises the user viewing the source of the requested scanned converted data, the Internet optimized thumbnail image, or the Internet optimized pair.

7. The method of claim 4, in which the test examination comprises the user viewing the requested scanned converted data, the Internet optimized thumbnail image, or the Internet optimized pair, for signs of corruption.

8. The method of claim 4, in which the test examination comprises the user subjecting the requested scanned converted data, the Internet optimized thumbnail image, or the Internet optimized pair, to a virus scan.

9. A method for virus resistant image transfer, comprising:
a user opening a computer connection;
the user selecting data;
the user generating a plurality of Internet optimized thumbnail images associated with the selected data;
the user converting the selected data to an Internet optimized format;
the user creating a plurality of Internet optimized pairs of the selected data and the thumbnail images;
the user generating a thumbnail image wall from the thumbnail images and the converted data;
the user compressing all Internet optimized pairs and the thumbnail image wall;
the user connecting to a server; and
authenticating the user by the server.

10. The method of claim 9, the method further comprising:
an operation indicating that authentication of the user fails; and
closing the connection to the server.

11. The method of claim 9, the method further comprising:
the user uploading, to the server, the converted data, the Internet optimized thumbnail image, the Internet optimized pair, and the thumbnail image wall;
the user extracting the converted data, the Internet optimized thumbnail image, the Internet optimized pair, and the thumbnail image wall;
the user scanning for viruses the converted data, the Internet optimized thumbnail image, the Internet optimized pair, and the thumbnail image wall;
the system cleaning from viruses the scanned converted data, the Internet optimized thumbnail image, the Internet optimized pair, and the thumbnail image wall; and
the system storing the cleaned converted data, the Internet optimized thumbnail image, the Internet optimized pair, and the thumbnail image wall.

12. The method of claim 11, further comprising:
a client requesting stored scanned converted data, the Internet optimized thumbnail image, the Internet optimized pair, or the thumbnail image wall;
the client connecting to a server;
the server authenticating the client;
the client uploading the requested scanned converted data, Internet optimized thumbnail image, Internet optimized pair, or the thumbnail image wall, to a client device;
the client conducting an examination of the uploaded scanned converted data, the Internet optimized thumbnail image, Internet optimized pair, or the thumbnail image wall;
if the examination is successful, the client storing, using, or transferring the requested scanned converted data, the Internet optimized thumbnail image, the Internet optimized pair, or the thumbnail image wall; and
if the examination is not successful, the user closing the connection to the server.

13. The method of claim 12, in which the examination comprises the user viewing the requested scanned converted data, the Internet optimized thumbnail image, the Internet optimized pair, or the thumbnail image wall, for relevance.

14. The method of claim 12, in which the examination comprises the user viewing the source of the requested scanned converted data, the Internet optimized thumbnail image, the Internet optimized pair, or the thumbnail image wall.

15. The method of claim 12, in which the examination comprises the user viewing the requested scanned converted data, the Internet optimized thumbnail image, or the Internet optimized pair, for signs of corruption.

16. The method of claim 12, in which the test examination comprises the user subjecting the requested scanned converted data, the Internet optimized thumbnail image, or the Internet optimized pair, to a virus scan.

17. A method for providing a level of virus protection for a thumbnail image, comprising:
a user opening a computer connection;
the user selecting data;
the user generating an Internet optimized thumbnail image associated with the selected data.

18. The method of claim 17, further comprising:
the generating of an Internet optimized thumbnail image associated with the data is not successful;
a warning message appears to the user that the data is not safe to use.

19. The method of claim 17, further comprising:
the user converting the selected data to an Internet optimized format;
the user creating an Internet optimized pair of the selected data and the thumbnail image;
the user compressing all Internet optimized pairs;
the user saving selected data and compressed Internet optimized pair.

20. The method of claim 19, further comprising:
the user generating a thumbnail image wall from the thumbnail images and the converted data;
the user compressing the thumbnail image wall; and
the user saving the compressed thumbnail image wall.

21. A system for executing a method for virus resistant image transfer, comprising:
a computer configured to access electronic sources of information;
a connection to a local network; and
a connection to the Internet;
in which a user uses the computer to execute a method for selecting data, generating an Internet optimized thumbnail image associated with the selected data, converting the selected data to an Internet optimized format, creating a pair between converted selected data and a thumbnail image, and compressing the pair.

22. A device for executing a method for virus resistant image transfer, comprising:
a main memory;
a storage;
a processor; and
a communication interface;
in which a user uses the memory, the storage, the processor, and the communication interface to execute a method for selecting data, generating an Internet optimized thumbnail image associated with the selected data, converting the selected data to an Internet optimized format, creating a pair between converted selected data and a thumbnail image, and compressing the pair.
